(19) United States
(12) Patent Application Publication
(10) Pub. No.: US 2003/0105535 A1
(43) Pub. Date: Jun. 5, 2003

(54) Unit controller with integral full-featured human-machine interface

(76) Inventor: Roman Rammler, Houston, TX (US)

Correspondence Address: David M. Ostfeld, Chamberlain, Hrdlicka, White, Williams & Martin, Suite 1400, 1200 Smith Street, Houston, TX, 77002, US

(21) Appl. No.: 10/011,419

(22) Filed: Nov. 5, 2001

(51) Int. Cl. G05B 11/01; G05B 15/00

(52) U.S. Cl. 700/17; 700/83; 700/19; 700/20

(57) ABSTRACT

An integrated unit controller/human-machine interface is disclosed which incorporates high-speed redundant control, sequence of events, supervisory control and data acquisition, alarm handling, trending & historian, process graphics and “open” communications in a compact form factor enclosure (the front panel less than 5×6 inches). The unit controller is composed of two primary hardware elements: the controller module (single or redundant) and the palm type computers (P/PC)-based human-machine interface (HMI) with touch screen. The controller covers a wide span of applications, from single process unit control to networked multi-unit management.

### BACKGROUND

1. Field of the Invention

The present invention relates to controllers and process monitors, and more particularly to electronic controllers and process monitors.

2 Prior Art

Industrial control and monitoring systems have taken many forms in the prior art. In the past, the advanced control functions, redundancy and the human-machine interface (HMI) portions of a control system have been functionally segregated and physically separated. Furthermore, if a process controller included an integral HMI, it was limited to a fixed, non-intelligent (without PC, no windows-type) front panel. This has limited the operator's local process interface ability since complete information was available only via one or more segregated HMI. Also, unit control applications have been restricted because stand-alone process controllers did not integrate advanced control functions nor did they incorporate redundancy/fault-tolerance.

It is an object of the present invention to have a control system that will integrate the functionality of advanced control, redundancy and windows-type HMI into a comprehensive process unit controller.

It is a further object of the present invention to combine a unit controller with a user-friendly operator interface and with process optimization capability and fault-tolerance at the distributed control level, where it has the most benefit to the end-user.

It is an additional object of the present invention to have a process unit controller whereby a user could take advantage of the latest state-of-the-art of process control (including proprietary optimization functions) and display features (animated-dynamic graphics, trend/historian, alarms/events) in an “all-in-one” package that has a compact form factor.

### SUMMARY OF THE INVENTION

A process controller is disclosed that integrates advanced control and redundancy with a palm-type PC (P/PC) Windows-type human-machine interface (HMI).

In the preferred embodiment of the invention, the invention combines optimized process control and visualization with easy access over commercial networks such as Ethernet or the Internet. The invention is comprised of a control system of elements including, but not limited to combined I/O-Control-Communication board(s), the palm-type computer (P/PC) operator interface and the Control-Visualization-Communication application programs. The elements are merged into a 1/8 DIN (138×68 mm) form factor that is common for industrial analog controllers. This new concept of unit control offers the following unique advantages:

Flexibility—Advanced control and optimization in a stand-alone compact package.

Fault Tolerance—1:1 redundancy to assure maximum safety and availability.

Reliability—Redundancy includes μP, communication and I/O on a single board

Scalability—Fits virtually any size of Unit application.

Built-in Graphical Interface—Provides instantaneous feedback to the operator.

Integrated Datalogging and Trends—Eliminates the need for external recorders/loggers.

SER—1 ms resolution between time-stamped events for sequence of events recording capability.

Integral Connectivity—Ethernet OPC and Internet communication connect Operation, Maintenance and Management.

200 Volt Common-Mode Rejection—Provides high noise immunity for process inputs.

Wiring Simplicity—All wiring originates from, or terminates at, the same location at the rear of the controller.

Universal Control Board—Integrates intelligence, I/O and communication on one board. Minimizes Spares and Space.

Cost Savings—All required hardware and software is contained within a single compact package.

The present invention further provides “open” access through OPC (Ole for Process Control) to information and data in the process controller with both high-speed (Ethernet) and Internet communication interfaces included. It can also import and export real-time data using XML format. This brings XML support to the unit control level, allowing for dynamic and automated data exchange between applications at all levels—from unit control to corporate asset management.

Other features and advantages of the invention, which are novel and non-obvious, will be apparent from the following detailed description in conjunction with the accompanying illustrations in which is shown a preferred embodiment of the invention.

### DESCRIPTION OF THE DRAWINGS

For a further understanding of the nature and objects of the present invention, reference should be had to the following drawings in which like parts are given like reference numerals and wherein:

FIG. 1 is an overview block diagram of the preferred embodiment of the present invention, illustrating the general function of the basic unit controller elements;

FIG. 2 is a side, rear and front view dimensional drawing indicating the compact size of the inner controller and its preferred embodiment of the present invention;

FIG. 3 is an overview diagram of the unit controller with integrated human-machine interface (P/PC-based HMI) illustrating the relationship of the major components and the links between them, primarily hardware architecture of the preferred embodiment of the present invention;

FIG. 4 is a schematic illustrating communications networks;

FIG. 5 shows a typical compressor and turbine unit control;

FIG. 6 shows a typical enterprise-wide automation with multiple unit controllers;

FIG. 7 shows an illustration of a human machine interface (HMI);

FIG. 8 shows a screen capture of graphics configuration display;

FIG. 9 shows a typical set of pre-configured compressor displays;

FIG. 10 shows a trend and a trend history display;

FIG. 11 shows an alert summary and an alarm history display;

FIG. 12 shows the text dialog box for the OPC Server interface

FIG. 13 shows the Configuration File Interface

FIG. 14 shows the unit controller HMI Internet Toolkit

FIG. 15 shows typical wireless data communications

FIG. 16 shows a single stage anti-surge scheme selection/display and data entry;

FIG. 17 shows an anti-surge algorithms selection help, single stage compressor;

FIG. 18 shows base condition data entry, single stage compressor;

FIG. 19 shows a multi-stage anti-surge scheme selection/display;

FIG. 20 shows compressor performance curve display/entry;

FIG. 21 shows an anti-surge algorithm and application display;

FIG. 22 displays Hp vs Q² (polytropic head versus squared volumetric flow) section table display;

FIG. 23 shows anti-surge parameter table display;

FIG. 24 shows tools for flow calculation; and

FIG. 25 shows polynomial conversion.

### DETAILED DESCRIPTION OF THE PRESENT INVENTION

General

Although this invention is susceptible to embodiments of several different forms, a preferred embodiment will be described and illustrated in details herein. The present disclosure exemplifies the principles of the invention and is not to be considered a limit to the broader aspects of the invention to the particular embodiment as described.

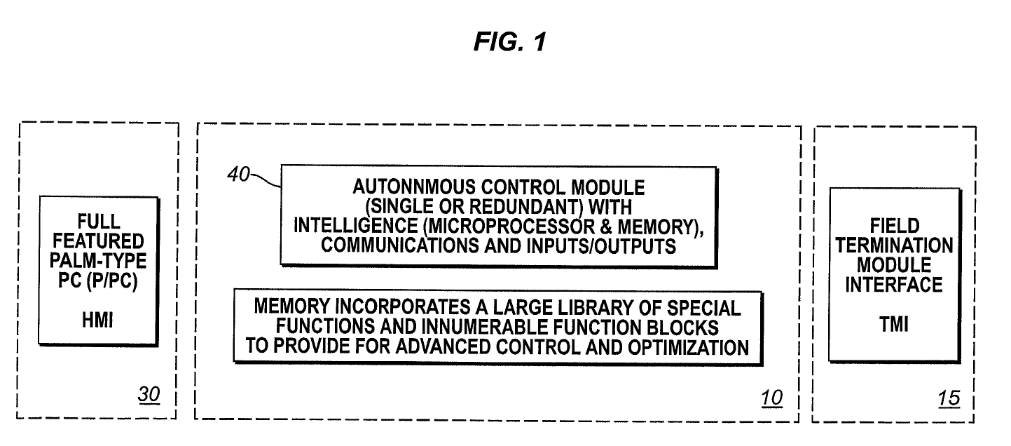

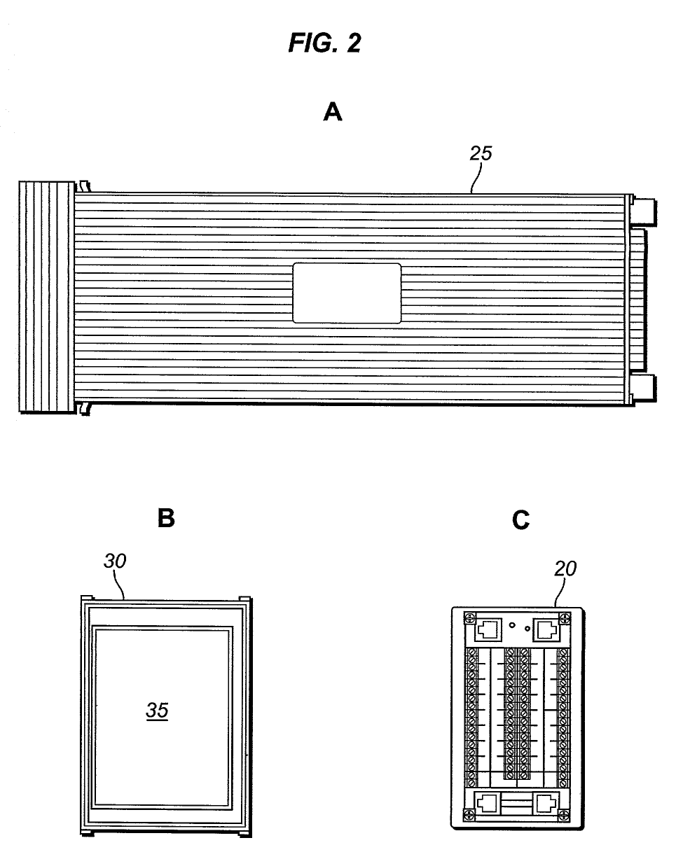

As shown in FIGS. 1 and 2, unit controller 10 includes a field termination module interface (TMI) 15. TMI 15 includes a termination panel 20 mounted at one end of chassis 25. The other end of chassis 25 has mounted on it a full-featured palm-type PC (P/PC) graphical operator interface (HMI) 30. P/PC 30 has typical graphic capability 35. In between the P/PC 30 and the field termination module interface 15, there is mounted an autonomous control module 40. Autonomous control module 40 may be a single or redundant unit with intelligence (microprocessor and memory) as well as communications and inputs and outputs, the communications and inputs and outputs interfacing directly with the TMI 15. These inputs and outputs are connected (not shown) to the field terminals 20. The autonomous control module 40 further includes memory, which incorporates a large library of special functions and function blocks to provide for advance control, SOE, fall-back algorithms, oscillation detection/control, expression vectors, load allocation, dynamic lookup table, constraints and the like.

The unit controller 10 is applicable to compressors, reactors, columns, boilers and many other process units. It can also automate the surrounding process and utilities of the major process equipment groups. The unit controller 10 not only enhances established process unit control, but also incorporates new concepts that offer new benefits to virtually any automation application.

Hardware Architecture:

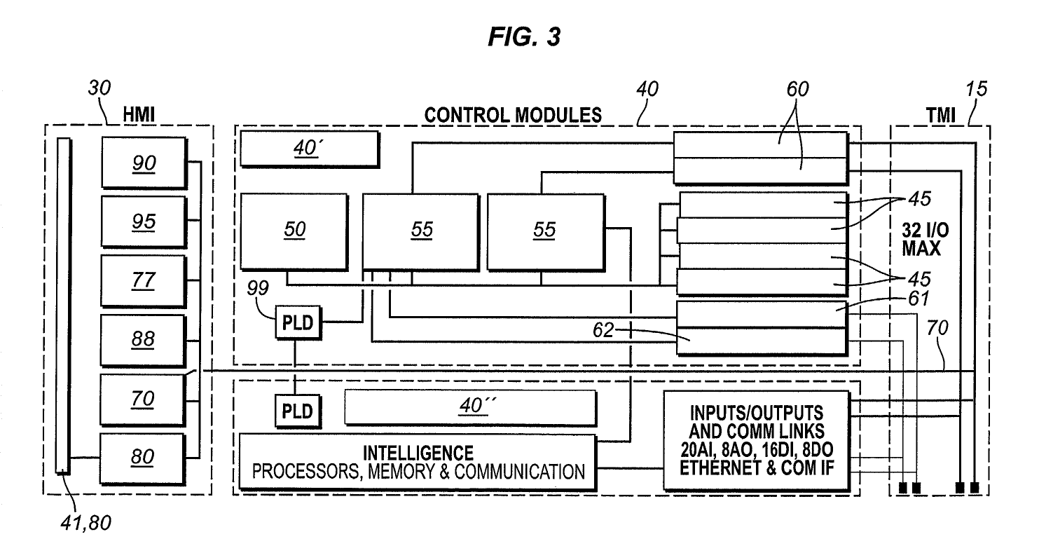

As shown in FIG. 3, the single board control modules 40 are connected to the plant's/unit's field instruments (not shown) through its termination module interface (TMI) 15 panel. This interface optionally accommodates redundant control modules 40′, 40″, to provide high fault tolerance. The control modules 40 include the I/O signal conditioning/processing 45, the intelligence (microprocessors and memory) 50, 55 and the communications 60, 61, 62. The control modules run identical operating systems and application firmware. Each module 40′, 40″, is also responsible for the communications (Ethernet 60, Modbus 61 and Comm 1 62) network function. The PLD 99 (programmable logic device) determines which module 40′, 40″, is in control.

An embedded palm-type PC (P/PC) 30 is provided which communicates via OPC 70 (Ethernet 60 or RS 232/485/Comm 1, 62) with the control module(s) 40 and is used to provide the operator interface 41, including a color LCD. The LCD panel 41, displays information and menus and incorporates a touch screen 80 for user inputs. With its color display (back-lit TFT) 41 and CPU 88 (including memory 77), the operator interface 41 has the flexibility to provide a wide range of pre-formatted displays and a clean interaction with all operation applications. In addition, a CompactFlash header supports modem 90 interfaces for Internet connection (solid or wireless) or memory expansion. Also, an additional USB interface port 95 provides a link to USB devices.

Controller Configuration Approach

The functions of controller 40 can be freely combined. An illustrative listing of the functions is set out in Table 1 below. The user may connect any function to any other function within the same or other unit controllers 10 within a system. The capability to select from over one-hundred algorithms makes the unit controller 10 uniquely qualified to adapt the controls to special process/utility applications and to include controls of unit controllers of surrounding equipment/utilities (not shown).

Pre-configured Strategies

The unit controller 10 can be provided with a variety of control strategies pre-configured by the factory. Of course, since these strategies are composed of standard function blocks (Table 1), they can be changed as required in the field (authorized personnel only; user password/key is required)

TABLE 1
Controller Function Library

INTERNAL/VIRTUAL DISCRETE
DISCRETE INPUT
MULTI-STATE DISCRETE
LET
Loads (inserts) the specified Tag,
Label or Constant us the loop MSV
AI LOAD
Loads value of pre-configured
analog input Tag
TEMP COMP
Performs temperature compensation
PRESS COMP
Performs pressure compensation
INPUT SIGNAL SWITCH
Auto selection for dual transmitter
range.
ANALOG/LOGIC
Serves us analog to logic converter
CONSTRAINT
Provides Setpoint Optimization
PID BATCH (Sub-Function)
PID algorithm.
PID RATIO/BIAS (Sub-Function)
PID AUTO RATIO (Sub-Function)
PID AUTO BIAS (Sub-Function)
PID CASCADE (Sub-Function)
PID GAP (Sub-Function)
SET PID
Inserts specified parameters into
PID equation.
LOAD PID
Load PID parameter as MSV
MULTIPLY
DIVIDE
ADD
SUBTRACT
SQUARE ROOT
CALCULATOR
Performs specified calculation
ABSOLUTE
Takes absolute value of MSV
LOGARITHM
EXPONENTIAL
SEQ CONTROL
Determines the number and duration of
states in sequence control
INTERLOCK ALARMS
Signifies an alarm condition in Seq
Control function
DISCRETE STATUS CONTROL
Changes the status of one or more
discretes based on the sequence state
SEQUENCE
Generates ramp and hold for Sequence
control function
ARRAY
Array (Table) of Values
MSV CH-D
MSV change based on discrete states
MSV CH-A
MSV change based on Analog Value
MINIMUM SELECTOR
Selects the minimum or the maximum
MEDIAN & HI/LO SELECTOR
Inserts the medium, high or low as MSV
LEAD/LAG
Provides first order lead/lag algorithm
DEAD TIME
Provides for MSV delay algorithm
VELOCITY LIMIT
Limits the rate of change of the MSV
TOTALIZER
Integrator including Cut-off level, time
base, etc
UNCOND AO
MSV is directly linked to analog output
AO LOAD
Loads pre-configured AO to analog
output
DISCRETE OUTPUT DEF
PULSER
Pulses a Discrete Output
GOTO A
Step sequence change based on analog
value
GOTO AT
Timed step sequence change based on
analog value
GOTO D
Step sequence change based on discrete
input
GOTO DT
Step sequence change based on timed
discrete input status
GOTO
Unconditional step sequence change
GOTO-M
Step sequence change based on PID
mode
DCH-M
Discrete status change based on PID
mode
O/C CONTROL
Open-Close (on/off, start/stop, etc)
control with feedback alarm. Valve with
limit switches
BOOLEAN EXP
Boolean expression (logic calculator)
AND
OR
INVERT
LATCH
TIME DELAY
D STAT
Discrete status change
RVD ACCESS
Restricted Virtual Discrete Access
EVENT COUNTER
Counts and totalizes discrete status
changes
START/STOP MOTOR CONTROL
Start-stop switch with pulse and
interlock feature
RESET VD
Resets an internal/virtual discrete
DISCR STATUS BASED ON MSV
M INTERLOCK
Mode selected interlock
MCH-D
PID mode change based on discrete
status
OSC MONITOR
Oscillation amplitude monitor
LOOK UP TABLE
Provides interpolation for up to 98 X &
Y values
ALARM MANAGEMENT
Manages alarms by Group or single Tag
COMM DO
Peer-to-peer communication alarm
discrete output
TIMER/STOPWATCH
AVERAGE
CONTROLLER/RTU CLOCK
Accesses internal clock
IF THEN ANALOG
Functions as an “If-then-else” algorithm
based on
analog value comparison
IF THEN DISCRETE
Functions as an “If-then-else” algorithm
based on discrete status
ZERO LIMIT
Output is zero if the reference value is
negative
EXTEND PULSE
Sustains value of a boolean variable for
a defined length
MAXIMUM VALUE
MEAN VALUE
MEDIAN VALUE
RATE OF CHANGE
Computes the derivative of the value
DEADBAND
Checks the value (x) against low/high
limits
EXPRESSION VECTOR
Selects values or expression based on an
index

Communication Networks:

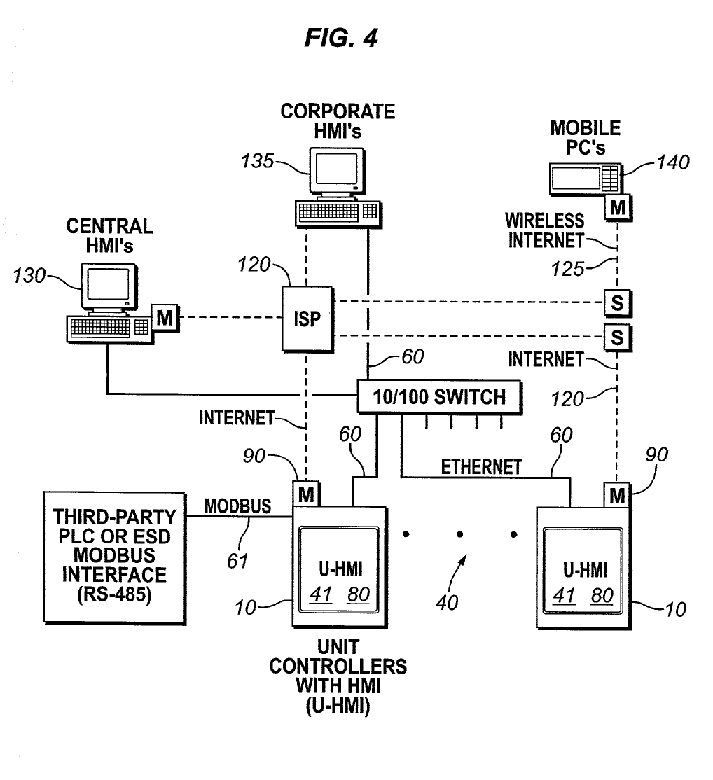

FIG. 4 illustrates the integrated unit controller's “open” connectivity. To be able to respond to alarms and diagnostics information/recommendation anywhere on the corporate Intranet (Ethernet) or on the Internet is unique for a unit control system.

The unit controller 10 combines Unit Control with Ethernet LAN (Local Area Network) 60 and modem 90 communications. It provides the communication tools required to build a complete advanced automation solution. The operator can use the unit controller's 10 integrated networking, then visualize and deliver the information to authorized users with Ethernet 60 and the Internet (hardwired 120 or wireless 125). With flexible connectivity between the control layer 40 and the Central HMI's 130-Corporate HMI'S 135-Mobile HMI's 140, the automation hierarchy is simplified. Further, the unit controller's 40 control board incorporates Modbus (serial 232/485) 61 communications.

The Windows CE-based Operator Interface of the unit controller 40 includes communications services such as COM (component-object module), Web server, XML import/export, and network routing. The user can interact with the process equipment and plant/utility (not shown) via standard Intranet/Internet technology through a Web-Browser.

Application Scalability

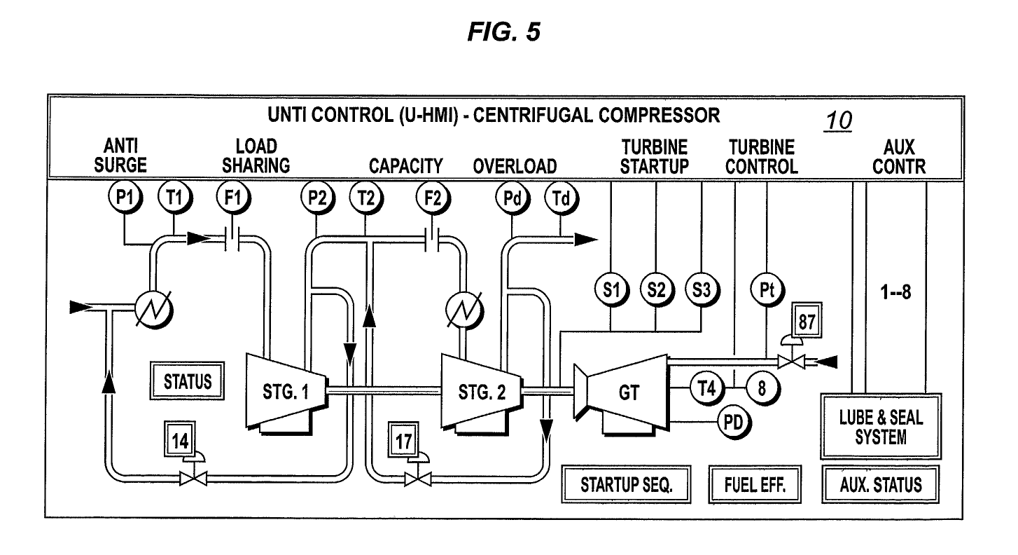

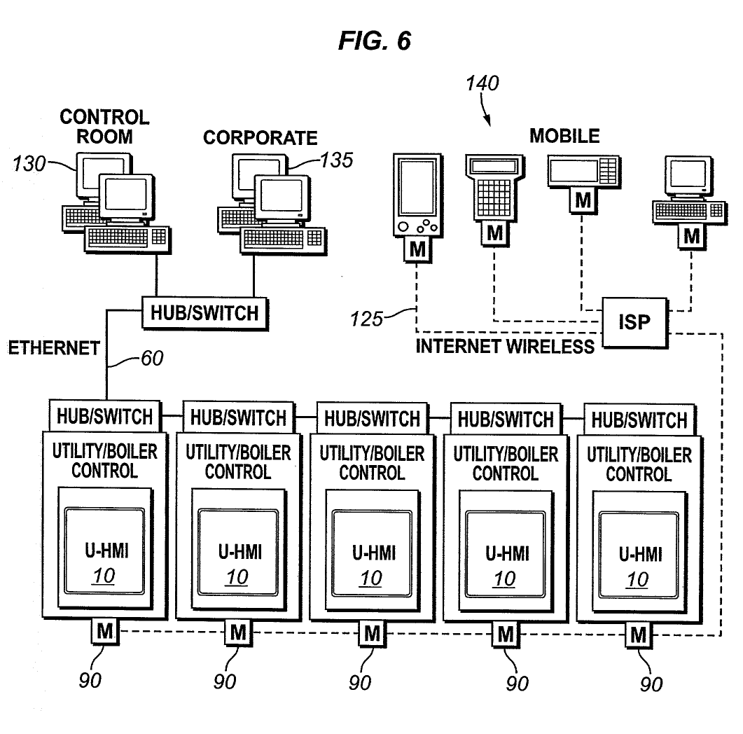

FIGS. 5 & 6 show the unit control 10 system's capabilities and flexibility to match the user's application—from single unit control to enterprise-wide automation projects. The modular architecture makes it easy to expand the system.

The unit control system opens up a large sphere of plant operation to automation. Its global environment for information and control provides not only total access and advanced processing within the automation system, but can also incorporate a central interface (control room 130), plant asset planning (corporate 135) and remote diagnosis (mobile 140). The unit control systems scalability permits the user to start “small” but allows for easy expansion to a total plant management system. System I/O (input/output) point capacity is up to 20000.

P/PC Human-Machine Interface (HMI)

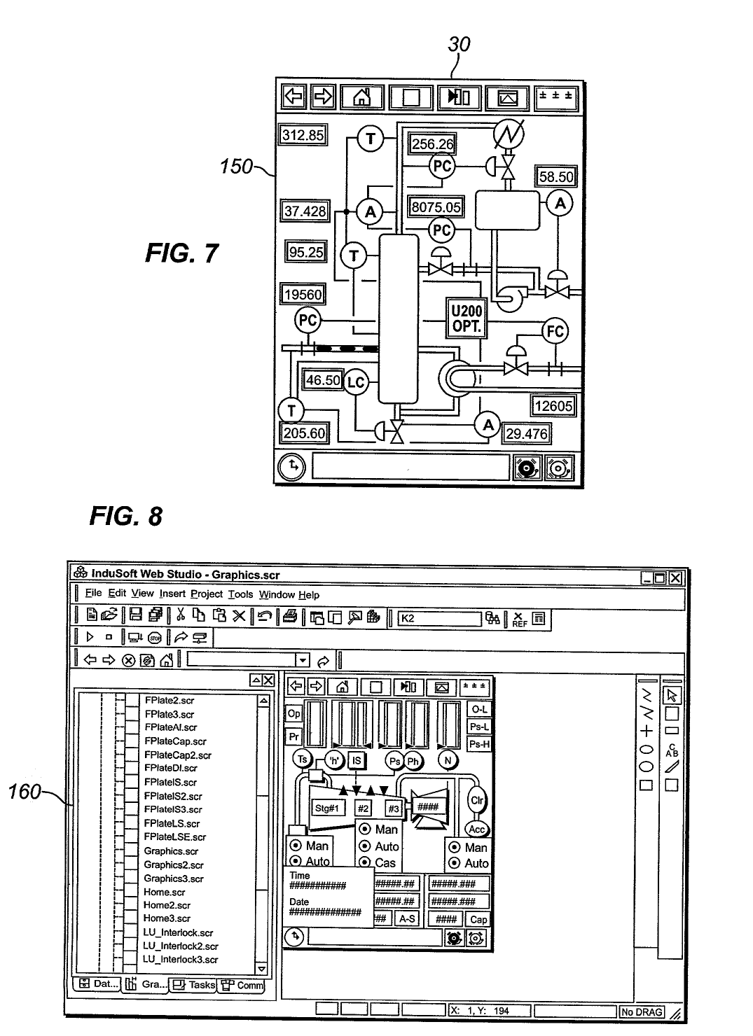

FIG. 7 shows an illustration of an HMI graphic display. To be effective in a small (P/PC size) footprint, the operator interface 30 must be ergonomically pleasing and comfortable to the user. While this may seem to be a fairly easy goal to achieve with today's well accepted Menu Bar interfaces, a number of elements come into play with a process controller-based environment that must be brought into proper relationship with the operator—elements such as animation, instant alarm access, prevention of accidental value entry, value setting accuracy, etc.

The unit controller display architecture is flexible, yet clean and simple in appearance and interacts with every application in the same manner. The windows, menus, etc. are consistent looking and behaving.

The prompting and pre-formatted type display hides the complex window access procedure and simplifies operation to a point where a virtually untrained person can easily navigate between displays. It provides an intuitive means of interacting with the process.

The touch panel is the primary device for operator interaction with the screen. Direct touch or a pen (stylus) are used for contact with the screen.

Operator Interface Software Architecture—

HMI Process Display Formats

The HMI 30 provides three general applications . . .

Graphics 150: Illustrates the interface to the process in face-plate and graphical format

Alarm Summary: Provides traditional alarming and acknowledgment capabilities

Trend/History: Replays real-time and historical data in trend chart format

Overview of HMI Features

The unit controller 40 incorporates a P/PC based full-featured human-machine interface—HMI 30. It is menu-driven and requires no programming knowledge.

HMI Microcontroller—

Intel StrongARM microprocessor 88

32 MB Flash Memory 77

32 MB SDRAM Memory 77

Integrated LCD controller 41

Ethernet and USB connectivity 70, 95

CompactFlash slot 90

Card Speaker

Database Management—

Object oriented database

Fill-in-the-blank definitions

Data accessible system wide

Standard Environment—

Based on Microsoft's DNA architecture

Industry standard operating system-CE

Distributed COM

XML technology

Multi-User—

True multi-user capabilities

Supports multiple P/PC's, operator/engineering/management workstations

Networkable on popular local and wide area nets

Web enabled to serve HTML pages over the Web with real-time data

Allows sub-division of process responsibilities to different users

Business Interoperation—

Unit control can be integrated into a total business system.

Integrates Unit Control and Business Asset technology

Imports and exports real-time data and reports in XML format

Protected data ownership and security

OPC Client/Server—

Enables communication with control modules

Open systems OPC link

Server identifier

Configurable data update rate

Notification on exception bases (deadband setting)

Standard GUI—

Based on WEB Studio, the graphical user interface offers object oriented easy to use graphics.

User-defined and pre-defined graphic displays. Used to monitor and control a unit process.

Pre-defined displays include:

Home; Proc. Graphics, Face-Plates; AIN/AO; DIN/DO; Loop Tuning; Interlocks; Alarm Summary, Alert Summary; Trend; Historical Trend; Diagnostics;

Scripting language including math expressions, statistic and logical functions, module activation functions, etc.

Build hierarchies and networks of displays

Displays real-time & historical data

Translation Tool for multi-language operation

Time-Scheduled Tasks—

Provides time-based user defined operations

Event types: Reports, Recipes, Calculations, data logs, match/logic functions or any program

Scheduling intervals from seconds to years

Quickly defined and interactive

Schedules application programs

Alarms and Alerts Processing—

Provides comprehensive alarm reporting

SOE (sequence of events) capabilities

Individual or multiple alarm acknowledgements

Remote Ack (acknowledge)

User definable priorities

User definable status colors (start, ack, norm)

Archive storage and call back

Real-Time and Historical Trending—

All data base points may be selected for trending

Selectable plot scales, time spans, colors, grid sizes

Up to 8 plots per window

Selectable curve type (X/t, X-Y)

Save On Trigger or Save on Tag Change selection

Archive storage and call back

Recipes and Reports—

Facilitates assessment of unit performance

Easy creation of reports (without programming tool)

Load recipes and retrieve values in XML format

Graphic Display Configuration

Graphics provide an object oriented human-machine interface (HMI) 30 applications for the unit controller 40.

FIG. 8 shows a screen capture of a graphic display configuration on a workstation PC. The graphics software 160 of the unit controller HMI 30 is a runtime-only version of the workstation PC graphics. The software is provided by IduSoft. All configurations of graphic displays are made using a workstation PC, such as central HMI 130, and then downloaded to the HMI 30 of the unit controller. Once in run-time mode, the user is able to execute all runtime functional dynamics that have been added/defined during configuration.

HMI 30 Visualization/Control

A complete set of drawing and animation tools is furnished. One can create graphic objects and build displays using any combination of drawing tools (boxes, lines, circles, text, etc.); save the graphic objects in a library, add expressions and animation.

Universal OPC (Ole for Process Control) Connectivity—

The graphical displays are connected to the unit controller control board(s) 40 using the OPC protocol to access the dynamically updated real-time data and alarm points.

Dynamic Object Animation—

Considering the small (P/PC size) footprint, it is important to provide high-performance animation effects based on dynamic real-time links. The dynamic action tool offers rotation, animation, analog color, flash, etc.

HIMI Example—Centrifugal Compressor

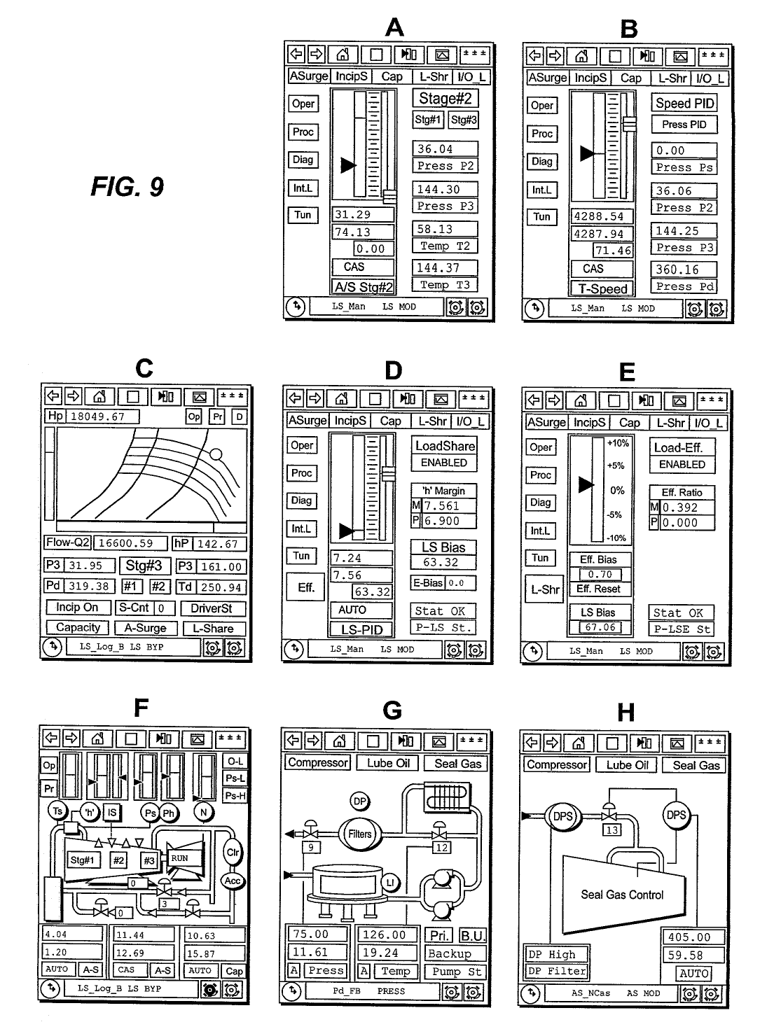

FIG. 9 illustrates examples of a Compressor Unit HMI 30 for a typical centrifugal machine.

The HMI is designed to facilitate operation at all levels. It permits simplified access to the unit, provides a logical display hierarchy and a choice of navigation for interaction with the process.

From operator displays to maintenance screens to engineering displays, the unit controller HMI covers the full interface spectrum. The color display represents an HMI with full DCS/SCADA capabilities. It provides a complete “window” on the process by which one can operate/control, maintain and manage the process unit.

Trend/Historian Display

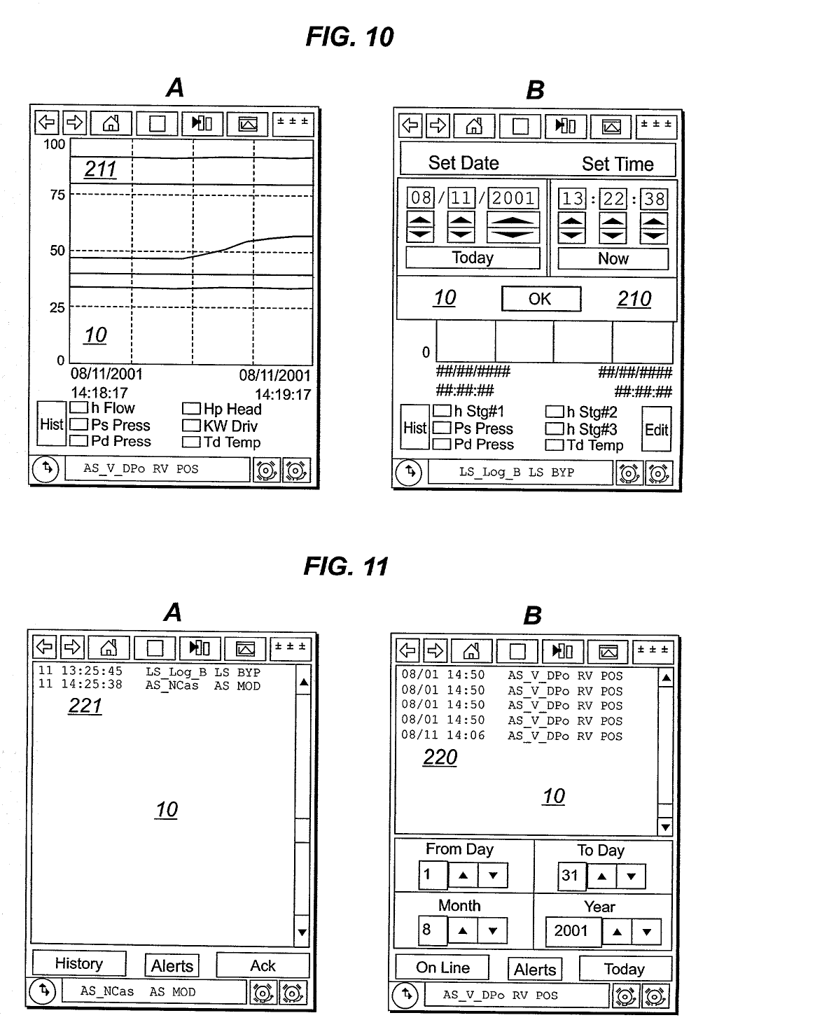

Behind the Trend displays 210 and 211 of FIG. 10 is real-time trend reporting and analysis tool.

Trend capability provides simultaneous viewing of real-time and historical data. Trend display type is in the popular Strip Chart Recorder format.

Historical Replay

The Trend History display provides for a comprehensive means of viewing process and calculated data over periods of time. Historical data can be retrieved with convenient date/time selection buttons.

Alarm & Event Handling

FIG. 11 shows an Alert Summary and an Alarm History display. The ability to display and meaningful disseminate alarm/event data is vital. Alarm and event detection and processing takes place in the control module 40. The alarm and event notification at the operator interface 30 includes summary displays (Alarm and Event Summary 220) and history displays (alarm and Event History 221). Audible annunciation is also provided.

Integral Communication Networks

The design of the communication networks for the unit controller 10 includes several levels to provide the best information distribution. A multi-tiered strategy has been taken in delivering information everywhere by using much of the new technology now available.

Communication Services

The integral unit controller 10 communication architecture incorporates the following networks . . .

Ethernet IEEE 802.3 Carrier. The OPC Server provides for industry standard protocol access.

Serial MODBUS Interface—RS-232 or RS-485. Can be configured as master or slave.

Internet Tools. E-Mail, Web Publishing and XML support (requires CompactFlash-type modem).

Wireless Networking. Use of wireless Internet access and wireless LAN technology.

All of the networks are based on industry standard communication, providing for an “open” system architecture.

Ethernet

Ethernet as specified in IEEE 802.3 and used in the unit controller 10 operates at 10 Mb/s and is a multinode connection topology that handles up to 1,024 nodes on twisted pair, fiber optic, or coax.

Twisted-Pair Ethernet 10Base-T is very economical and uses telephone wiring and standard RJ-45 connectors. This type of Ethernet is wired in a star configuration and requires a hub or switch

Fiber Optic Ethernet 10Base-T is used to extend Ethernet segments.

Fast Ethernet (100Base-TX) is essentially the same as the original Ethernet except the transfer rates are 10 times faster at 100 Mb/s. Another differences is that Fast Ethernet includes a mechanism for auto-negotiating of the media speed.

Ethernet, the de facto standard—layered with industry-standard protocols such as OLE for process control (OPC)—makes Ethernet-based solutions very attractive and cost effective for open connectivity and interoperability between process control and business applications

OPC (OLE for Process Control)

The OPC specification documents a set of standard COM (Component Object Module) interfaces defined standard objects, methods, and properties. DCOM enables an additional level of functionality for OPC, so a client application can use objects located on other networked computers. Therefore, an HMI or DCS/SCADA software package can exchange real-time data with the unit controller's 10 OPC server running on any computer on the network. The OPC specification also defines a standard mechanism for OPC client applications to browse OPC servers and to access named data items contained in OPC servers.

OPC Server Interface—

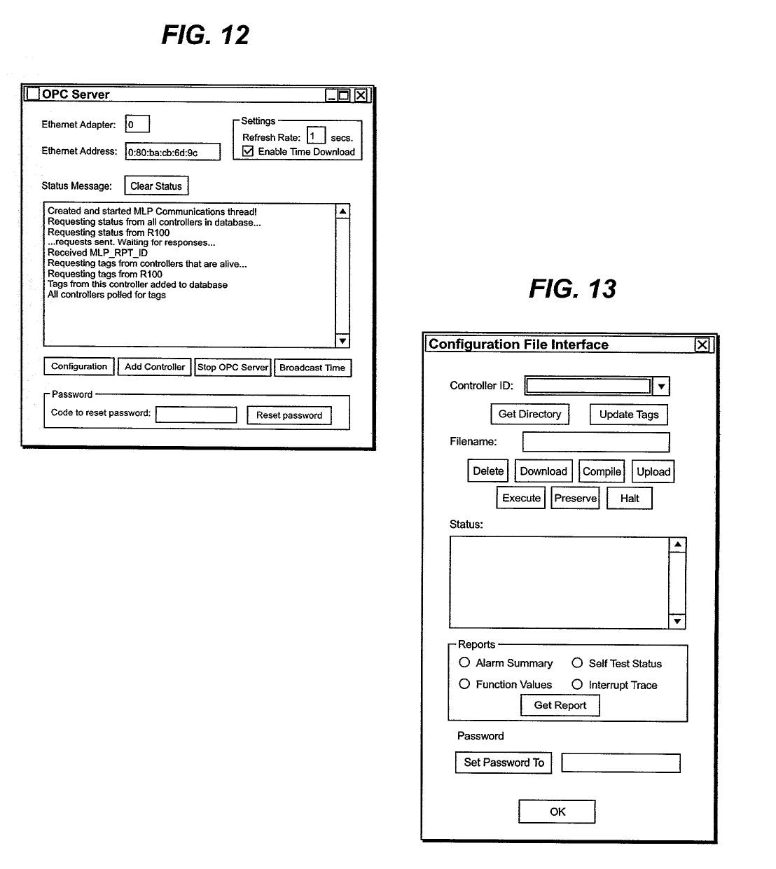

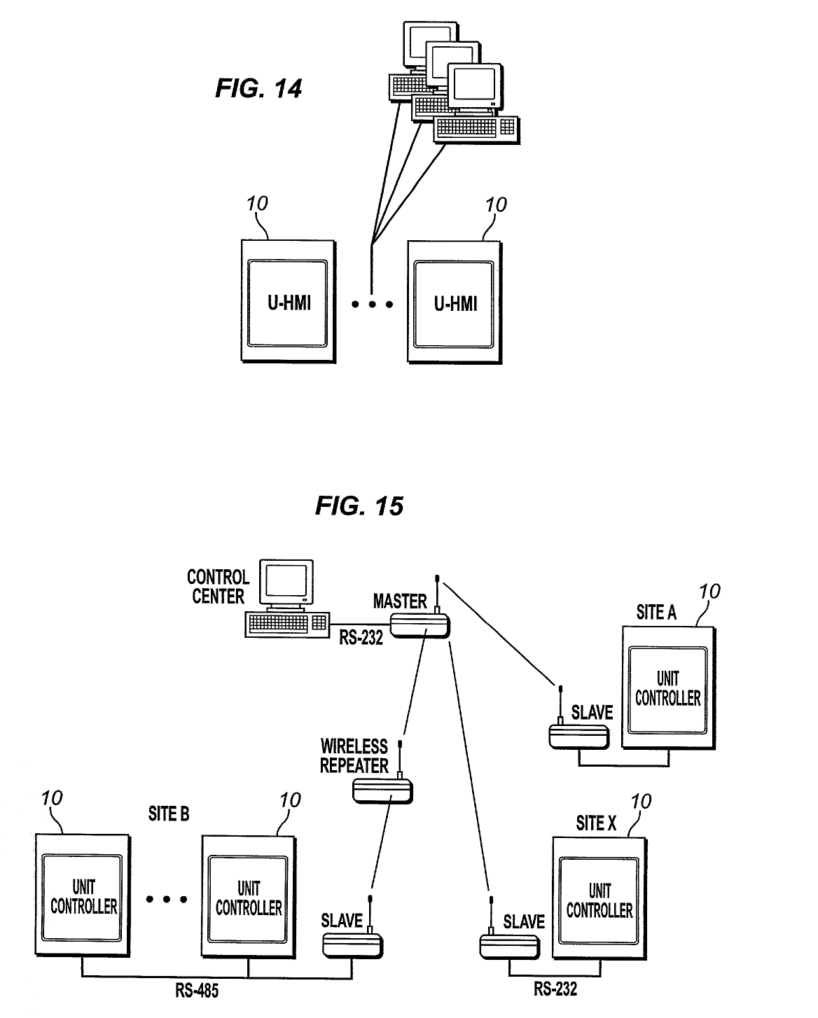

The OPC server communicates with the unit controllers 10 through the Ethernet adapter. A text dialog box (FIG. 12) displays the ID (Ethernet Address) of the adapter used for communications with the controllers. This field cannot be changed during run-time. If the computer has more than one adapter, and the controllers 10 are on a network which is connected to an adapter which does not have the ID of zero (0), then one will need to configure the OPC server to point to the correct adapter ID. This can be done by using the registry and changing the adapter ID key in the OPC Server group. This change in Adapter ID should be effected only when the OPC Server is not running.

Configuration File Interface

FIG. 13 shows the Configuration File Interface. This control allows a user to interact with the unit controllers 10. Most of the interaction with the controllers tends to be related to the configuration files for the controllers. The OPC server allows a user to download, compile, execute and delete configuration files on the controllers. It is assumed that the user has created a configuration file on the user's PC using a text editor. Clicking on the Configuration button (FIG. 12) brings up the File Interface window.

Most of the functions supported by the window are self-explanatory. The OPC server will provide a list of controllers in the list box. This list will contain only those controllers which have responded to queries from the OPC server or have sent in their heartbeat message to the OPC server at some time. Just because a controller is displayed in the list, does not imply that the OPC server will be able to communicate with it. The controller could have gone off-line after it had sent some heartbeat (on-line diagnostic signal) messages to the OPC server. In such a case, an interaction with that controller will timeout and the OPC server will display a time-out error in the status box on the Configuration File Interface dialog box.

Modbus Interface—RS-232 or RS-485

The MODBUS communication link permits the unit controller 10 to converse with DCS/SCADA systems from other vendors or to interface data from a variety of PLCs. The unit controller can act as either a MODBUS master or slave. In its master (supervisory) mode the unit controller can accommodate up to 2500 PLC points.

The MODBUS protocol provides for multiple devices to share a common communication link. To prevent simultaneous transmissions on the BUS only one device may transmit data at a time.

Internet Tools

The unit controller Human-Machine Interface (HMI) 30 can be provided with built-in Internet functionality (requires CompactFlash type modem) for publishing documents and replicating images of the front panel (HMI) displays. The HMI environment is based on Microsoft's DNA architecture, which includes COM, DCOM and XML technology. The user can build his/her own Web server to make the application automatically update as animated virtual instruments across the Web, using client-pull or server-push update methods. From the built-in server, one can respond to several clients connected to the program.

Security level provisions are incorporated to limit access to the unit controller displays and data. Access can be controlled based on user name and password, or based on a valid IP address.

The Internet component of the unit controller HMI 30 also includes e-mail capabilities. Using these features, e-mails can be sent automatically when alarms occur.

Wireless Data Communications

FIG. 15 shows typical wireless communications. A number of technology alternatives—both licensed and license free—are available to meet the growing demand for wireless data communications in industrial automation applications. Spread spectrum radio systems are increasingly accepted for installations that otherwise would have used microwave or dial-up/leased line solutions.

The radio modem converts the serial RS-232/485 unit controller 10 system into a wireless information network by transparently converting unit controller commands and data into wireless, spread spectrum communications. Modems are available that transmit data at rates of up to 115 kilobites per second (115 Kbps).

A wireless radio system includes one master modem connected to a PC Serial COM port. At each unit controller location, a slave radio modem connects to the unit controller module Comm1 port 62. Repeater radio modems can be used to increase the communication distance or to achieve line of sight by routing the communications signals around obstructions.

Control Strategy Flexibility, I/O Handling, Fast Loop Execution and SOE—All Incorporated on the Single-Board Control Module

The control system uses a series of linked blocks to provide special control strategy flexibility and fast loop execution. Control strategies, calculations, etc., are configured by inserting the required preprogrammed functions one after the other in a building-block fashion. The blocks (functions) are automatically linked (“softwired”) by the configuration program to form complete pre-programmed loops and strategies. Linked blocks can reside in a single unit controller 10 or in different units. The extensive tracking capability of the system ensures bumpless and balanceless data transfer with the result that the control and the process are not disturbed during control mode changes (man-auto-cas), under feedforward and feedback transfer or during fall-back strategy switching.

Analog Input Characterization

The analog input blocks accept the analog field inputs and prepare the data for use by the controller's loop/strategy firmware.

Analog inputs are sampled as part of the loop execution (input conversion scheduling is based upon loop scan time). The analog input functions convert (scale) the raw input data to engineering units. They perform signal conditioning such as square root, thermocouple/RTD linearization and input filtering. The result is a conditioned input value in engineering units.

The output of the conditioned input value can be linked throughout the control system (in the same controller unit 10 or to other units).

Discrete (Contact) Input Characterization

The discrete (on-off contact) input functions accept a contact field input and prepare the status data for use by the controller loop/strategy firmware.

Contact inputs are sampled at a high frequency and can be conditioned with filtering (debounce). Inputs are time-stamped to a one (1) millisecond resolution in order to provide first-out sequence of events detection (SOE).

The output of the conditioned discrete input status can be linked throughout the control system (in the same controller unit or to other units).

Basic Control Strategy Execution Tasks

Although the controller 10 is designed to meet several types of control—Continuous, Batch, Startup/Shutdown Sequence, Logic and SCADA—all types execute the same basic control loop strategy tasks.

Loop/Strategy Configuration

Loops or strategies are pre-configured by simply inserting into the loop blocks the functions selected to implement the chosen control strategy. As discussed previously, any input or inputs may be referenced (configured) in any of the loops as many times as required. Function label references enable the user to access the output of any function (loop block) in the same controller or in other controllers.

Main Signal Flow

During loop execution, data “loaded” or “entered” into a block is processed by the function configured in that block, or in other words, input signal links and any other data are accessed during block execution. The processed data is presented as the function output and is normally passed to the following block to be processed by the next function.

The data value may be altered by each function and therefore changes as loop execution proceeds through the blocks. The value is replaced by a new value if a link function is inserted in one of the loop blocks.

The signal value of analog data is in engineering units, thus allowing development of loop/strategy configuration in real engineering values.

Loop/Strategy Execution Cycle Time

All loops are normally updated ten times per second (to allow standard analog/discrete filtering). However, the user may choose a different update frequency for each loop/strategy, if other than the standard update time of 100 milliseconds is desired. A loop/Strategy scan time in the range from ten (10) milliseconds to 300 seconds may be selected for each loop by simple operating data entry.

With a loop/strategy execution time capability of 10 milliseconds (100 times per second) the controller can handle high speed control applications such as: Interlock executions, turbine governor positioning, liquid pipeline response algorithms, compressor surge control, reactor control, etc.

Control Loop/Strategy Output Section

The outputs of a loop are normally sent to the on-board digital to analog converter. However, a configuration may be such that a loop is used without a direct output or two or more loops may share the same output.

The control loop/strategy output sections are part of the loop and usually perform three general functions . . .

Tracking: Tracking is normally executed to provide balanced output in open-loop conditions for mode transfer and control strategy switching. The tracking scheme can be effective even when it involves multiple control loops/strategies.

Analog Output Functions: The primary purpose of the analog output functions is to prepare a specific analog value for output to the field. An output data register is provided for storing the analog output value. Output limits, rate of change, verification, direct/reverse action etc. are incorporated into the analog output functions.

Discrete Output Functions: The primary purpose of the discrete output functions is to prepare a specific on/off state for output to the field. Of course, the discrete output data registers (same as for analog output registers) can also be accessed by loop/strategy functions.

On-Line Configuration Editing

The controller configuration was designed from the beginning to offer safeguards against unauthorized changes. High security is provided by requiring users to enter access levels and passwords when performing configuration or database changes.

Although basic configuration changes are seldom required for pre-configured control applications, field experience has shown that during the lifetime of a process plant application, controller flexibility is essential in order to adapt to revised operating/equipment conditions and to optimize energy consumption and throughput.

The unit controller configuration concept permits full on-line control strategy editing by an authorized user, not just limiting formatting of function blocks of the common, less flexible systems. With this feature, the user can add or delete functions, make changes to the control strategies and interlink strategies/loops any time, provided that security authorization has been obtained. Linkage between control loops and/or units is accomplished by labels, thus minimizing errors during configuration modifications. Status of control functions (PID, totalizer, latch, loop-mode etc.) is retained during configuration if basic configuration topology is not changed.

Complete Integration

The new concept of incorporating all control, input/output handling and communication on a single-board control module 40 significantly increases system reliability. Both general purpose and optimization functions are included. This new integration capability opens up a large sphere of plant units to advanced automation.

The following pages describe some of the unique pre-programmed functions contained in the unit controller 10 . . .

Look-Ahead Constraint Optimization Function

The function is used with the PID control function to optimize the process setpoint. Optimization is achieved by increasing or decreasing the setpoint at a defined rate. The setpoint up or down ramping is conditional and depends on the status of the defined conditions. The conditions may be discrete or Boolean expressions or comparison (<,==,>). The condition Booleans are, as a rule, tied to an analog variable that is in some manner an indicator of the process capacity or throughput.

For example, product is transferred to a mill where it is ground and only the finely ground portion of the product is removed. The product volume in the mill may be used to increase or decrease the mill feed setpoint so that the mill load will be kept at the optimum level and will not be allowed to be depleted or exceed the maximum allowable. In this case the millfeed setpoint will be tied to the RAMPUP=(PRODUCT VOLUME<X) and RAMPDN=(PRODUCT VOLUME>Y) parameters, where X and Y are the minimum and maximum product volume allowable.

Another example would be the setpoint positioning in a centrifugal/axial compressor anti-surge control application. The setpoint is ramped toward the compressor operating point to ensure fast response in cases where the compressor operating point is in the high flow region but starts to decrease rapidly. The predictive action is configured to decay automatically while the compressor operating point is moving at a normal rate toward the surge control line.

The function requires definition of four parameters.

Parameter 1—Condition: This parameter defines the Boolean variable (discrete or expression) which enables or disables the function.

Parameter 2—Rampup: This is the Boolean variable which when true (1) causes the function to ramp up (increase) the loop setpoint. Setpoint ramping is maintained while the Rampup Boolean remains true.

Parameter 3—Rampdn: This is the boolean variable which when true (1) causes the function to ramp down (decrease) the loop setpoint. Setpoint ramping is maintained while the Rampdn Boolean remains true. The Rampdn parameter may be a discrete controlled by some process variable or event or may be a Boolean expression or comparison (==,>=).

Parameter 4—Rate: This is a constant and defines the rate at which the loop setpoint will be ramped up or down. This parameter does not alter or affect in any way the setpoint ramp rate entered in the loop auxiliary data.

Dynamic Look-Up Table

The function is a two-dimension dynamic lookup table, which accepts a number of values as input, and outputs an equal number of values, one for each input value. When the input is between two defined values the output is linearly interpolated. The input values are considered to be the X-axis and the output values the Y-axis.

The number of X and Y values may be limited, such as twenty, ten for the X-axis and ten for the Y-axis and, to each X-axis value there must be one and only one corresponding Y-axis value.

Alternatively the X-axis and the Y-axis values may be written in tagged arrays. In this case the number of elements in each array can be more than ten and the arrays must be defined in loop steps preceding the step in which the function is configured.

Entries in arrays can be either constants or tags of variables and for every X-axis value there preferably should be only one corresponding Y-axis value.

The function requires definition of two parameters and the X and Y values:

Parameter 1—Reference Tag: This defines the tag of the analog input or internal (virtual) analog, which is the independent variable, the input to the function.

Parameter 2—Number of Table Entries: Defines the number of X-axis values that will be entered. During parameter definition, the X value and the Y values are entered.

Oscillation Detection and Control

Signals from the flow/pressure/current transmitter in conjunction with oscillation the detection function can be used as input to the incipient control PID of a centrifugal or axial compressor. The output of the incipient PID controller acts as override to the main anti-surge PID controller via a selector function.

In typical compressor control applications, incipient surge control is added as a backup algorithm to the primary and fallback anti-surge control algorithm. This increases the reliability of the anti-surge control system. Incipient surge could be used as the primary/main anti-surge control algorithm, however, since the concept depends on high-speed, clean process measurement (flow, pressure, current) that involves high-speed transmitters and special installation consideration, normally it is not recommended that incipient surge control by itself (alone), be utilized for compressor anti-surge control.

Incipient Surge Phenomena

Before the compressor reaches the actual surge point, rapid oscillations occur. Compressor field tests have confirmed this phenomenon as an indication of impending surge. However, since this surge phenomenon has special characteristics for each compressor, it is (in practice) not always easily measured and special signal characterization/filtering is required.

An analog conditioning module or the high-speed digital algorithm is required to collate pre-surge oscillations into useful data for control purposes.

To prevent high frequency noise from interfering with the pre-surge detector, a special high frequency filter is used. The effects of low frequency variations caused by normal process changes and/or operator setpoint changes are isolated by a low frequency, cutoff filter adjustable from 0.2 to 12 HZ (5 HZ default).

A high speed transmitter must be used when implementing incipient surge control techniques.

The incipient control backup concept has been successfully used for compressor surge tests for many years. However, the high speed implementation in a digital controller is new.

Expression Vector

The grammatical production,

primary-->“{” args “}” “[” expr “]” is an expression vector. It may be an l-value or r-value and even permits mixed data types among the arguments.

1. Semantics.

The expression (expr) is evaluated and indexes the list of arguments (args) which begin with argument zero. If the index is too large or small (ie negative), the first argument is used. Exactly one of the arguments is used during the current scan. Only the selected argument is evaluated. (Contrast with expression functions arguments which are always evaluated.) If all of the arguments are l-values, the expression vector may be used on the left of an assignment.

2. Examples of expression vectors.

Reset DAD VD101 in states 3 and 4:

{ , , , VD101, VD101}[STATE]=0;

{ , , , VD101=0, VD101=0}[STATE];

Set virtual analog to one of several values:

VA101={VA106, 17, VA103+5.7}[I];

Move some things around:

{A, A[K], VD101, ISW10, (I=0, K=K+1, K=0?K>10, VAI101)}

[I=I+1]={VA101, VD201}[J=0 ? J=J+1>=2, J]

Single-Board Fault-Tolerance Through Redundancy (Including I/O)

The unit controller is designed from the beginning to offer safeguards against unit and component failures, and allows failures to be located and repaired quickly.

Fault tolerance in the controller is achieved through redundant control board architecture. The redundancy employs two 40′, 40″ parallel control boards; each containing its processor, memory, communications and I/O circuitry. Thus, redundancy is provided throughout—from the input/output circuitry through the processor/memory and the communication.

Setting up applications is simplified with the unit controller, because the duplicated system operates as a single package from the user's perspective. The user terminates transmitters and actuators at a single wiring terminal and configures the controller with one set of application functions. The controller manages the rest.

Extensive on-line diagnostics on each control board detect and report operational faults. All diagnostic information is stored in system variables. If a failure is detected, an alarm is activated to inform the operator and a backup board is automatically enabled. The architecture allows for a simple plug-in control board exchange. Reconfiguration is automatic and control is restored to normal within seconds—without a process upset.

Uninterrupted communication and control is provided by automatically transferring all configuration and communications to both, the primary and backup control module. There is a complete transparency in the reserve control module. Apart from notification of failure, there is no change in the operator interface. The user has no installation or cable connection requirements. Backplane data links enable the modules to copy the I/O and control configuration and to assume virtually immediately the I/O and control functions in case of a malfunction.

Redundant Ethernet Media

Each controller board 40 incorporates two Ethernet Modems 60 to offer redundant media support for fault-tolerant network operation. The Ethernet carrier has two independent connections 60 and the network hubs/switches can include self-healing redundancy.

Redundant Line Power Supply

Since the loss of power could bring down the control modules, the external 26VDC power supply is normally provided in a redundant configuration.

Both power supplies operate continuously. On the controller, both 26 VDC sources are diode-isolated to prevent the failure of one from affecting the other.

Fault Tolerant Control Configuration

High system reliability is not only a function of hardware redundancy; fallback control strategies are equally important. The controllers' functions and configuration architecture is structured to provide safe strategy fallback in the event the certain transmitter or analyzer malfunctions

Anti-Surge Engineering Tool

The compressor anti-surge control engineering is automated with the anti-surge engineering software package—an intuitive vehicle for engineers to eliminate complex anti-surge selection and calculation procedures. This configuration tool does not change the basic approach to compressor anti-surge control (algorithms like Hp,sim, simplified polytropic head, versus h, differential pressure across an orifice plate have been in use for over 20 years), but it provides a new innovative component that makes sophisticated control selection simple and minimizes errors.

Configuration Procedures

The configuration program contains features to enter compressor anti-surge data (from either the performance curve or from actual surge tests), select the anti-surge algorithm and enter auxiliary data (such as transmitter ranges, bias, etc.). The software tool is also structured to optimize entered process information so that the multifaceted data can be turned into anti-surge control strategy selection automatically.

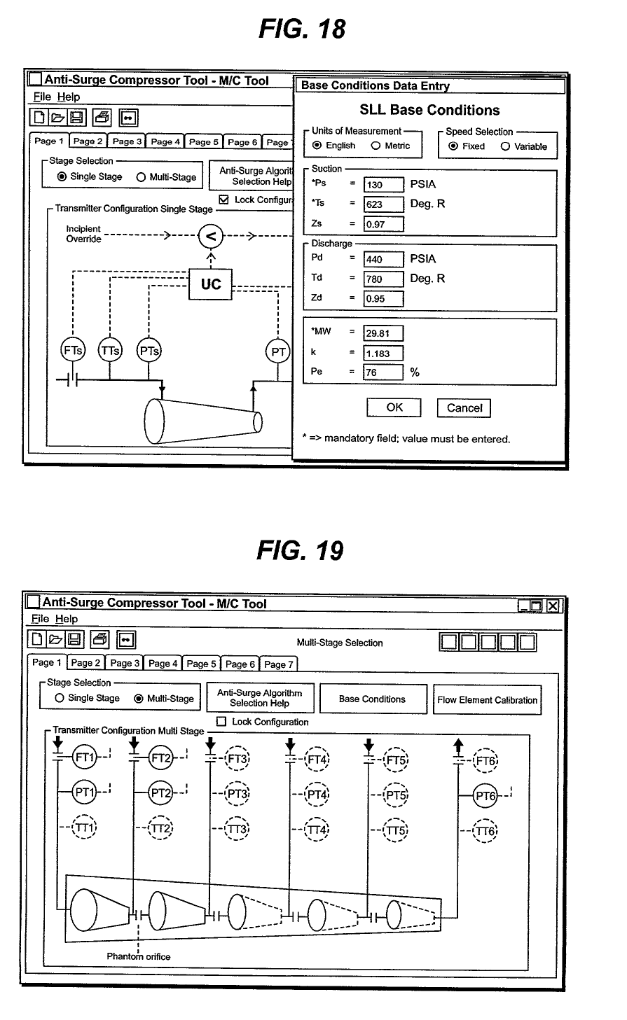

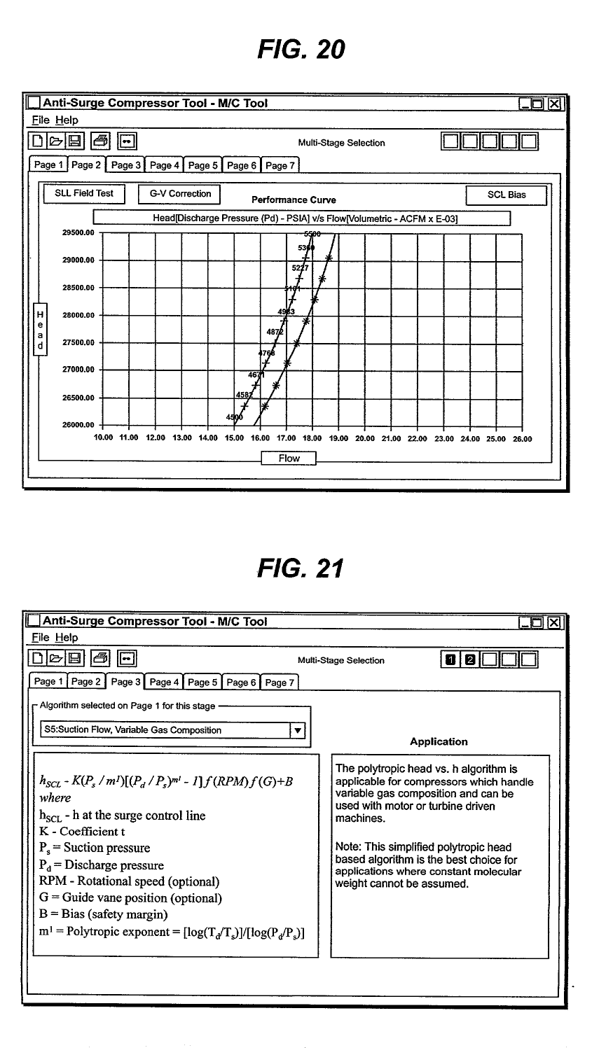

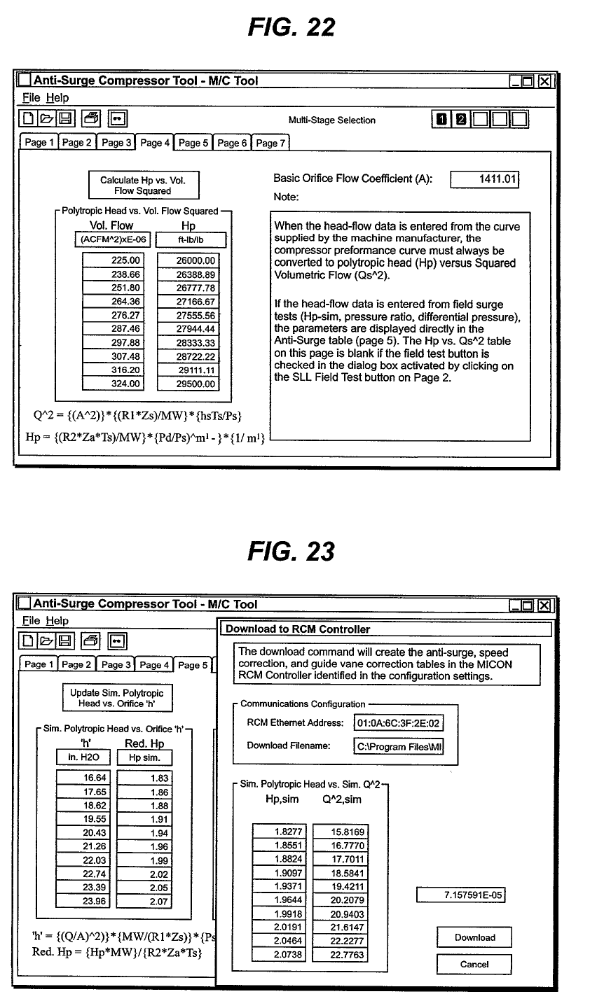

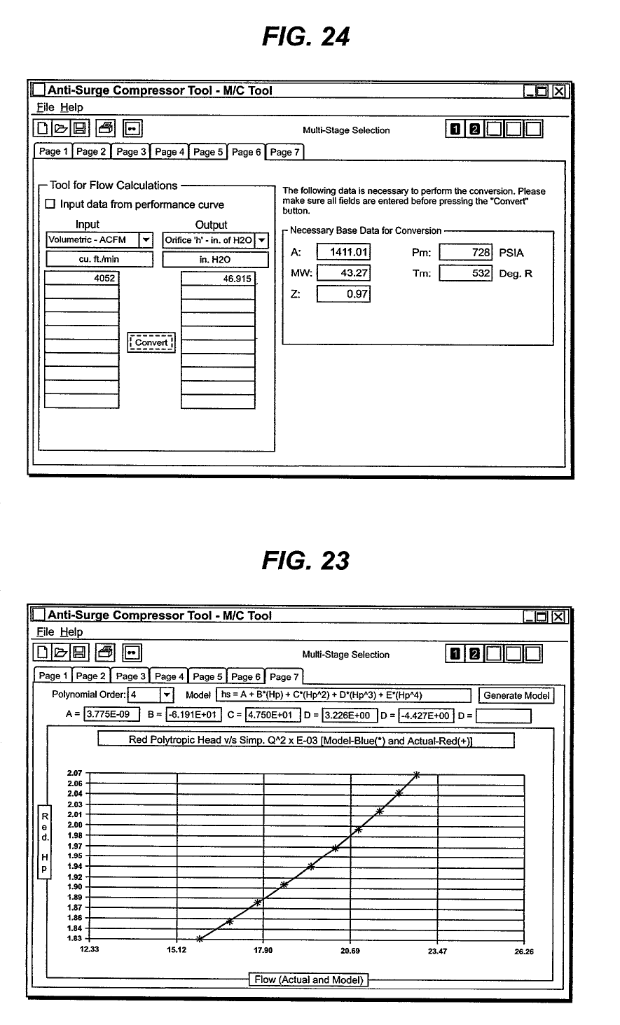

The configuration utility consists of several windows and pop-up templates. Help instructions/windows guide the user through the configuration procedures to the extent that the requirement for a configuration manual is practically eliminated. The software tool is provided in a Microsoft Windows based format. It includes the familiar File—New, Open, Save and Print features. The data entry/display is organized in seven pages: Anti-Surge Scheme Selection/Display and Base Data Entry (FIG. 18), Compressor Performance Curve (FIG. 20), Algorithm and Application Display (FIG. 21), Polytropic Head versus Squared Volumetric Flow Table (FIG. 22), Anti-Surge Parameter Tables (FIG. 23), Flow Calculation Help (FIG. 24), Polynomial Display (FIG. 25).

Anti-Surge (A/S) Adaptation

The Anti-Surge control is adapted to the specific application by entering the appropriate parameters on the Process/Instrument Data Entry screens as follows:

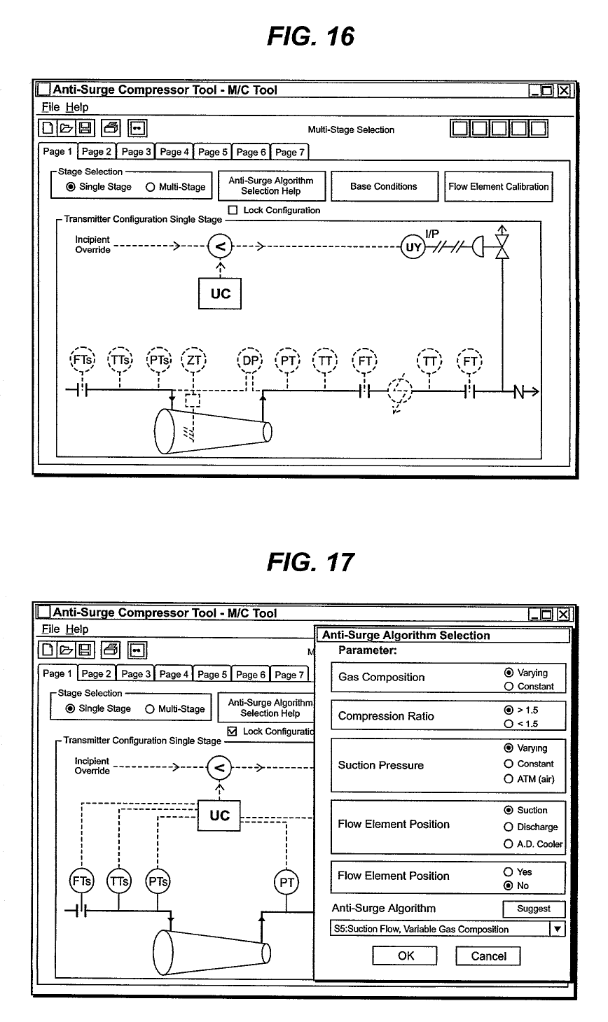

Select Compressor Type (FIG. 16): Depress either Single-Stage or Multi-Stage. For Multi-Stage machines choose the number of stages (click on graphic—FIG. 19) and select the Side Stream directions.

Choose the Anti-Surge Strategy Definition Method (there are two ways to select the strategy in the preferred embodiment): Selection with Anti-Surge Strategy Help/Verification pop-up and direct algorithm selection.

Verify that the transmitter configuration (auto selected by ‘suggested’ or picked anti-surge algorithm) meets the application requirement. Left click to delete/add transmitters. Right click to enter transmitter data.

Enter Compressor SLL Base Conditions and Flow Element Calibration: Choose Units (English-Metric) and Speed (fixed or variable) options and enter all data fields (mandatory entries for specific anti-surge algorithm are indicated by *). Then select Flow Element Calibration and enter or calculate the basic flow coefficient (A).

Select and Scale FLOW and HEAD (FIG. 20) to match units to compressor manufacturer's performance curve (for each Stage on Multi-Stage Machines). If the look-up table is used to enter field surge test data, click on SLL Field Test (the correlating Flow-Head units are automatically selected).

Enter Look-Up Table Points (double click on matrix) to establish the Surge Limit Line (SLL). For constant speed machines, enter two points (or several points, for varying MW) on the Look-Up Table. For variable speed machines enter points at several speed intervals (the RPM figure can be entered with each selected SLL coordinate). Use compressor performance curve from compressor manufacturer or enter points obtained from actual surge test data. Enter SCL Bias (Surge Control Line Bias).

Guide Vane Angle (G) Entry: For compressors with inlet guide vanes, guide vane position correction is accomplished via a pop-up Look-Up table. Enter the Base Flow at 100% open vane position and then enter the vane positions with the corresponding flow.

Data Entry Procedures

Compressor Type Selection—FIG. 16

Single-Stage or Multi-Stage

Anti-Surge Strategy Definition—FIG. 17

Pull down the Anti-Surge Algorithm Selection Help display and click on applicable conditions (gas composition, compression ratio, etc.) in the dialog box. Depress “Suggest” for selection of the recommended anti-surge algorithm.

Direct algorithm selection. Click on the arrow below “Suggest”, pull down the Anti-Surge Strategy menu (S1, S2, S5, etc.) and select the strategy.

Transmitter pick: Verify that the transmitter configuration meets the application requirement. Left-click to add/delete transmitters (re-verify anti-surge selection).

Enter Transmitter data: Right-click to enter transmitter ranges.

Base Condition—FIG. 18

Units of Measurement are either English or Metric.

Speed Selection—Fixed or Variable.

When entering the process variable data, the M/C Tool user has to be concerned that sufficient data is entered to allow for adaptation of the Performance Map to the selected Anti-Surge Algorithm.

Flow Element Calibration

If A (the basic flow coefficient) cannot be obtained from flow element calibration data, click the “Flow Element Calibration” button.

Data (Qmax, hmax, Pc, Tc, Zc) must correspond to flow transmitter conditions_(at location of flow transmitter, compressor suction or discharge).

Parameter Selection—FIG. 17

Gas Composition: If molecular weight changes more than ten percent, select Varying.

Compression Ratio: Verify Pd/Ps (absolute pressure) and enter >1.5 or <1.5

Suction Pressure: If suction pressure changes more than ten percent select Varying. Otherwise, select Constant. For air compressors, select ATM.

Flow Element Position: Verify and select flow element position. If possible choose suction position.

Guide Vanes: For compressor with inlet guide vanes, select Yes for Guide Vanes. Enter G-V Correction on the Performance Curve.

Anti Surge Algorithm “Suggest”—FIG. 17

Clicking on Suggest will display the recommended anti-surge algorithm.

For direct anti-surge algorithm selection, click on the arrow below Suggest and select the desired strategy.

If transmitters have been pre-defined and one or more transmitters are missing, they should preferably be automatically added to the P&ID diagram. Note, however, that if there is a pre-defined selection showing more transmitters than required by the recommended anti-surge strategy, the P&ID diagram will preferably not be updated.

SLL Base Conditions Entry—FIG. 18

Select Units of Measurement: English or Metric

Enter Speed Selection: Fixed or Variable speed compressor driver (Motor or Turbine)

Enter Process Data: Suction pressure (Ps), suction temperature (Ts), suction gas compressibility (Zs), discharge pressure (Pd), discharge Temperature (Td), discharge gas compressibility (Zd), molecular weight (MW), specific heat ratio (k), and polytropic efficiency (Pe).

Fallback Values: Predetermined values will be assumed if gas compressibility factors (Zs, Zd) are not entered

Back Calculation: If certain values are not available, the Configurator should preferably attempt to back calculate the parameters. For example; if no entry is made for suction pressure, the discharge pressure should preferably be used to back calculate the suction pressure.

Compressor Type Selection—FIG. 19

Multi-Stage (as shown in display)

Stage Configuration—FIG. 19

Select number of compressor stages by clicking on the compressor stages in the graphic

Choose each side stream flow direction by clicking on the side stream Arrow in the graphic

Phantom Orifice—Weight Flow Calculation Tool—FIG. 19

Double click the Phantom Orifice at the interstages to obtain weight flow values and orifice values.

Except that multiple stages are displayed, Anti-Surge Algorithm Selection Help, Base Conditions and Flow Element Calibration are similar to single stage displays.

Head Definition—FIG. 20

Select Head Units to match Performance Curve: Polytropic Head, Adiabatic Head, Discharge Pressure

Flow Definition—FIG. 20

Select Flow Units to match Performance Curve (at compressor stg. inlet): Volumetric Flow, Weight Flow

SLL Bias—FIG. 20

SLL Bias (safety margin) is entered as percentage of Flow (limit between 3 and 10%)

SLL Field Test—FIG. 20

Head and Flow Engineering Units (Head=Hp,sim′-Disch. Pressure, Flow=orifice ‘h’) are automatically selected in accordance with the chosen anti-surge algorithm if data is obtained from field tests.

Surge Limit Line (SLL) Data Entry—FIG. 20

Double-click on matrix

Use compressor performance curve from compressor manufacturer or enter points obtained from actual surge test data.

Enter Flow and Head data for at least two points. For variable speed machines enter points at several speed intervals (the RPM figure can be entered with each selected SLL coordinate).

If only three Flow/Head data points are entered for a variable speed machine check (click on) the quadratic interpolation.

Anti-Surge Algorithm Display—FIG. 21

Formula of preconfigured anti-surge algorithm is displayed for the selected compressor stage

If the displayed algorithm is not appropriate, return to Anti-Surge Algorithm Selection Help, and choose the desired algorithm.

Application—FIG. 21

Each anti-surge algorithm includes a short Application description. The user is preferably advised to read it carefully and consider his entries in the Anti-Surge Strategy Help/Verification dialog box.

Documentation (Print)—All M/C Tool displays

The simplest way to print is to click on the Print icon on the application's toolbar. The toolbar approach bypasses the dialog box and sends the entire M/C Tool document to the current default printer.

If a specific M/C Tool display is to be printed, pull down the file menu and choose Print.

When Head-Flow data is entered from the curves of the machine manufacturer, the Compressor Performance Curve is converted to Polytropic Head (Hp) versus Squared Volumetric Flow (Qs)².

If the Head-Flow data is obtained from field surge tests (Hp,sim-Pressure Ratio-Differential Pressure), the parameters are displayed directly on the Anti-Surge Table. The Hp vs Q² table is left blank if the Field Test button is checked.

The specific method used to calculate the anti-surge criterion ‘hSCL’ depends on the particular application. However, all calculations are based on the ratio of the polytropic head (Hp) to the volumetric flow squared in the compressor's suction.

When the compressor is provided with a variable speed driver (turbine) and/or inlet guide vanes, the surge limit line (SLL) will be a function of both RPM and G-V position. Experience indicates that these functionalities are relatively independent, therefore separate RPM and G-V function tables are used to normalize the SLL.

Since the true polytropic head or volumetric flow cannot be measured directly, their ratio is calculated as a function of reduced polytropic head (Hp,sim) versus suction orifice differential (hs).

Three concepts are used to compute the reduced polytropic head . . .

ΔP vs h algorithm: Assumption that the compression ratio term [(Pd/Ps)^{m′}−1]/m′ is linear and the polytropic exponent (m′) is a constant. Maximum reduced Hp,sim′.

Hp,siα vs h algorithm: Assumes that the polytropic exponent (m′) is a constant (α) for the gas compositions. m′=(k−1/k*Pe)=α.

Hp,sim′ vs h algorithm: The polytropic exponent is derived from the thermodynamic relationship, m′=[log(Td/Ts)]÷[log(Pd/Ps)]. This logarithmic relationship is substituted for the specific heat value based term in defining the equation for the simplified polytropic head. Hp,sim′ vs h is used for applications with widely varying gas composition.

The flow conversion tables (FIG. 24) are provided for users' convenience. Data source can be either from the Performance Curve or from manual entry.

Calculations

Orifice ‘h’

Actual Volumetric Flow

Weight Flow

Standard Volumetric Flow

The polynomial conversion (FIG. 25) of the anti-surge parameter display table is utilized if a polynomial function is used instead of a look-up table in the anti-surge controller. The conversion back preferably calculates the curve based on Simplified Flow×Ex06 (values before anti-surge algorithm constant and suction pressure compensation). Because many varying and difference embodiments may be made within the scope of the invention concept taught herein which may involve many modifications in the embodiments herein detailed in accordance with the descriptive requirements of the law, it is to be understood that the details herein are to be interpreted as illustrative and not in a limiting sense.

What is claimed:

1. A multi-loop, industrial unit controller, comprising:
a single, autonomous controller module, having—
an integral input/output section, including inputs and outputs, said section being within said module;
a function library stored in said module, said functions to manipulate the values of said inputs and outputs;
a configuration system stored in said module, said configuration system to interconnect said inputs and outputs and said functions; and
a human-machine interface connected to said module, including a display mechanism to request and display values of said inputs, said interface having a small form factor display.

2. The controller of claim 1, wherein said interface is embedded in said module.

3. The controller of claim 2, wherein said human-machine interfaces includes a palm-type computer.

4. The controller of claim 1, wherein said module is redundant.

5. The controller of claim 4, wherein said module has parallel single board redundancy.

6. The controller of claim 5, wherein there is control redundancy on said single board redundancy.

7. The controller of claim 1, wherein there is further included a communicator connected to said module.

8. The controller of claim 7, wherein said communicator has an Ethernet interface.

9. The controller of claim 7, wherein said communicator has an RS-232/485 interface.

10. The controller of claim 7, wherein said communicator has a web server.

11. The controller of claim 10, wherein said communicator includes Internet tools and wireless networking.

12. The controller of claim 1, wherein there is included a front panel, said human-machine interface mounted in said front panel.

13. The controller of claim 1, wherein said human-machine interface has a touch screen.

14. The controller of claim 1, wherein said human-machine interface has a color liquid crystal display.

15. The controller of claim 1, wherein said input/output section includes a one millisecond time stamping.

16. The controller of claim 1, wherein said display mechanism has a Windows-based operating system.

17. The controller of claim 16, wherein said display mechanism includes a palm-type computer having a Windows-based operating system.

18. The controller of claim 1, wherein said human-machine interface includes graphic capability.

19. The controller of claim 18, wherein said graphic capability includes drawing tools.

20. The controller of claim 19, wherein said drawing tools include animation tools.

21. The controller of claim 1, wherein said function library includes a dynamic two-dimensional look-up table that provides variable-speed compensation for centrifugal/axial compressor surge estimation computation.

22. The controller of claim 21, wherein said table includes automated anti-surge algorithm selection.
